(19) United States
(12) Patent Application Publication
(10) Pub. No.: US 2010/0112392 A1
(43) Pub. Date: May 6, 2010

(54) METHOD FOR REGENERATING A REFORMER

(75) Inventors: Stefan Käding, Zerrenthin (DE); Stefan Kah, Neubrandenburg (DE); Andreas Lindermeir, Goslar/Oker (DE); Marco Mühlner, Raduhn (DE)

Correspondence Address: DICKINSON WRIGHT PLLC, 1875 Eye Street, NW, Suite 1200, WASHINGTON, DC, 20006, US

(73) Assignee: ENERDAY GMBH, STOCKDORF (DE)

(21) Appl. No.: 12/302,452

(22) PCT Filed: Jun. 12, 2006
(86) PCT No.: PCT/DE2006/001008

§ 371 Date: Jan. 12, 2010

(51) Int. Cl. H01M 8/04; H01M 8/18

(52) U.S. Cl. 429/17; 429/19

(57) ABSTRACT

The invention relates to a method for regenerating a reformer fed with a mixture of fuel and an oxidant having a mean air number λ₁ in continuous reformer operation, the air number being varied for the purpose of regenerating the reformer. In accordance with the invention it is provided for that regeneration occurs in a shutoff phase of the reformer in that the reformer is operated during several successive time intervals with an air number λ₂ higher than in reformer operation (λ₂>λ₁). Again in accordance with the invention it may be provided for that regeneration occurs in a starting phase of the reformer in that the reformer is continually operated with an air number increased as compared to reformer operation λ₂>λ₁ until a critical temperature threshold is attained. The invention relates furthermore to a system including a reformer and a controller for implementing a method in accordance with the invention.

The invention relates to a method for regenerating a reformer fed with a mixture of fuel and an oxidant having a mean air number λ₁ in continuous reformer operation, the air number being varied for the purpose of regenerating the reformer.

The invention relates furthermore to a system including a reformer and a controller.

Generic methods have a wealth of different applications, they serving in particular to feed a fuel cell with a gas mixture rich in hydrogen from which electrical energy can be generated on the basis of electrochemical reactions. Such fuel cells find application, for example, in motor vehicles as auxiliary power units (APUs).

The reforming process for converting the fuel and oxidant into the reformate can be done in accordance with various principles. For instance, catalytic reforming is known in which the fuel is oxidized in an exothermic reaction. The disadvantage in catalytic reforming is the high amount of heat it produces which can irreversibly ruin system components, particularly the catalyst.

Another possibility of generating a reformate from hydrocarbons is steam reforming in which hydrocarbons are converted with the aid of steam into hydrogen in an endothermic reaction.

A combination of these two principles, i.e. reforming on the basis of an exothermic reaction and generating hydrogen by an endothermic reaction in which the energy for reforming the steam is won from the combustion of the hydrocarbons is termed autothermal reforming. Here, however, additional disadvantages are met with in that means of feeding water need to be provided. High temperature gradients between the oxidation zone and the reforming zone pose further problems in the heat balance of the system as a whole.

In general, the reaction in which air and fuel are converted in a reformer into a hydrogen-rich gas mixture can be formulated as follows:

$${C}_{n} {H}_{m} + \frac{n}{2} {O}_{2} -> \frac{m}{2} {H}_{2} + n CO$$

Due to incomplete conversion of the hydrocarbons in this endothermic reaction—not reflected by the equation—side products such as remnant hydrocarbons or soot can materialize which are deposited at least in part on the reformer, resulting in deactivation of the catalyst provided in the reformer possibly to such an extent that the catalyst is almost totally sooted up. This increases the drop in pressure in the reformer, resulting in it being ruined or needing to be regenerated.

In accordance with prior art such a regeneration is implemented particularly by burning off the soot deposited in the reformer. This can produce high temperatures resulting in permanent, i.e. irreversible damage to the catalyst or substrate material. Apart from this, large temperature gradients hamper controlling the reformer when burning off the soot is started. Since with an excess of oxygen, oxygen can materialize at the output of the reformer during burn-off there is no possibility of using a reformer regenerated in this way in an SO fuel cell system.

Described in DE 101 52 083 A1 is a reformer fed with fuel, vapor and oxygen. The solution proposed in DE 101 52 083 A1 to avoid overheating is to implement regeneration pulsed by elevating the air number of feed mixture for limited time intervals. It is unavoidable that this has an effect on reforming operation, resulting in, for example, the electrical energy obtainable from the fuel cell system being diminished.

The invention is based on the object of achieving regeneration of a reformer in avoiding an effect on reforming operation.

This object is achieved by the features of the independent claims.

Advantageous embodiments of the invention read from the dependent claims.

In accordance with a first aspect the invention is based on the generic method in that regeneration in a shutoff phase of the reformer is achieved in that the reformer is operated during several successive time intervals with an air number λ₂ higher than in reformer operation (λ₂>λ₁). In normal operation the reformer receives a continual feed of fuel and air at temperatures in the region of 650° C. and above. The reformer works in thermal equilibrium so that in stationary operation no increase in temperature is to be reckoned with. The deposits, however, as described, result in the catalyst being deactivated by degrees. It is particularly in mobile applications, for instance in passenger cars or commercial vehicles, that a fuel cell system and thus also the reformer is regularly shut off at least when the vehicle is idle for a lengthy period. Since no further electrical energy can be generated during the shutoff phase in thus having a negligible effect on reformer operation as regards energy generation, the shutoff phase can be made use of to advantage for regeneration. However, it is to be noted that also during the shutoff phase with a long-term elevation of the air number—be it by reducing the fuel flow feed, by increasing the air flow feed, or by both—overheating is to be expected which can result in the catalyst or even the complete reformer being ruined. This is because the reaction in burning off the soot C+O₂->CO₂ progresses exothermically.

Following complete burn-off of the catalyst oxygen is output at the end of the reformer which would result in the anode of a SO fuel cell being ruined. By the method in accordance with the invention it is now proposed to reduce the fuel feed pulsed during the shutoff phase, the individual pulses of which last for only a short time. Oxygen or air is applied to the soot deposit so that the oxidation process can commence, also resulting in an increase in temperature in the catalyst. But before the temperature is so high that the reformer could suffer damage, the fuel feed is again increased. Thus, at the end of a time interval with a reduced feed rate, part of the reformer is regenerated, i.e. rendered substantially free of soot or deposits. Reducing the air number results in the reformer cooling down to normal temperatures. This procedure can result in the reformer being partly regenerated or it can be repeated until the complete reformer is regenerated. Regeneration occurs zonally. Reducing the fuel feed pulsed now makes it possible that no oxygen gains access to the fuel cell anode which may prove problematic at fuel cell temperatures exceeding 500° C. since the anode material in the presence of oxygen can oxidate from Ni into NiO, resulting in the anode material being ruined and inhibiting the electrochemical reaction at the anode.

The invention is furthermore sophisticated to advantage in that the fuel feed rate amounts to zero during at least one of the successive time intervals. Due to the fuel feed being shut off completely during the successive time intervals, burn-off of the deposits is now more efficient. When the fuel feed is not completely shut off, water production in the reformer is increased. It is this water that is able to remove the soot and other deposits from the reformer in accordance with the equation C+H₂O->CO+H₂.

It may furthermore prove useful to measure the oxygen content in the substances leaving the reformer and the reformer translating into continuous operation when the oxygen content exceeds a threshold value. The oxygen content at the output of the reformer thus serves as an indicator of complete regeneration of the reformer. Keeping track of the oxygen content furthermore permits ensuring that no excess quantities of oxygen come into contact with the anode of the SO fuel cell.

In this context it is useful to measure the oxygen content with a lambda sensor.

It may likewise be provided for that the oxygen content is measured by a fuel cell. To save having to install a lambda sensor the electrical output values of the fuel cell can be used directly to detect an increase in the oxygen content. To determine the lambda value other sensing methods can, of course, be made use of, such as, for instance, infrared or CO sensing.

The method in accordance with the invention is particularly useful with a reformer having a dual fuel feed, when one of the fuel feeds works during regeneration with a feed rate which substantially corresponds to the feed rate in continuous operation. With a reformer having a dual fuel feed there is thus a greater possibility of varying the fuel feed rate. This particularly applies to the possibility of operating the reformer unchanged in part whilst in other portions of the reformer regeneration occurs by changing the function when this is desired during reformer operation, in other words, outside of the shutoff phase.

The method in accordance with the invention is in this context usefully sophisticated in that the reformer comprises am oxidation zone and a reforming zone, that the reforming zone is feedable with heat, that the oxidation zone is fed with a mixture of fuel and oxidant in using a first fuel feed, the mixture being feedable after oxidation of the fuel at least in part to the reforming zone at least in part, that the reforming zone is feedable with additional fuel by using a second fuel feed and that the second fuel feed works during the successive time intervals with a reduced feed rate. The additional fuel feed thus forms together with the waste gas from the oxidation zone the output mixture for the reforming process. By mixing the fuel with the waste gas a small A value is made available (for example λ=0.4) and in making use of heat an endothermic reforming reaction is achievable. As regards the regeneration in accordance with the invention it is to be noted that operation of the reformer in the oxidation zone can continue to run unchanged whilst only the second fuel feed is shut off or reduced.

It is particularly useful that the reforming zone can be provided with heat from the exothermic oxidation in the oxidation zone. The thermal energy resulting in the oxidation zone is thus converted in the scope of the reforming reaction so that the net heat produced by the process as a whole does not result in problems in managing the temperature of the reformer.

It is usefully provided for that the reforming zone comprises an oxidant feed via which additional oxidant is feedable, resulting in a further parameter being available for influencing reforming, in enabling it to be optimized.

The invention is particularly suitably sophisticated in that additional fuel is fed to an injection and mixing zone from which it can flow into the reforming zone. This injection and mixing zone is thus disposed upstream of the reforming zone so that the reforming zone makes a well mixed output gas available for the reforming reaction.

In this context it is particularly useful that the additional fuel is evaporated at least in part by the thermal energy of the gas mixture emerging from the oxidation zone, in thus enabling the reaction heat of oxidation to be also made use of to advantage for the fuel evaporation process.

It may furthermore prove useful in that the gas mixture generated in the oxidation zone is feedable to the reforming zone partly in bypassing the injection and mixing zone, in thus making available a further possibility of influencing the reforming process so that a further improvement of the reformate emerging from the reformer is achievable as regards its application.

It may be provided for that regeneration occurs during each shutoff phase of the reformer, in thus making an optimally prepared system available for the next reformer start.

In accordance with a second aspect the invention is based on the generic method in that regeneration occurs in a starting phase of the reformer in that the reformer is continually operated with an air number increased as compared to reformer operation λ₂>λ₁ until a critical temperature threshold is attained. During the starting phase, particularly on commencement thereof, the temperatures materializing in the reformer are uncritical, there thus being no need to select pulsed reformer operation for the purpose of regeneration. Instead, the reformer can be regenerated continually via the elevated air number.

It is particularly useful that the reformer can be operated in the starting phase with an air number λ≧1 in the reformer ultimately working as a burner, air numbers of λ>1 being uncritical with the relatively low temperatures of a downstream fuel cell system.

For example, it may be provided for that the critical temperature threshold is defined in that the reformer or its components feature temperatures between 450 and 650° C.

It is likewise conceivable that the critical temperature threshold is defined in that a fuel cell stack or its components downstream of the reformer feature temperatures between 450 and 550° C. Terminating regeneration during the starting phase, for example, at a fuel cell stack temperature of 500° C. avoids damage on the part of the anode due to excess oxygen entering the fuel cell stack when the temperature thereof is further increased.

The invention is sophisticated to particular advantage in that the reformer is regenerated following its starting phase by the reformer being operated during several successive time intervals with an air number elevated as compared to that in reformer operation. Pulsed operation is appropriate following the starting phase to avoid overheating.

It is expediently provided for that the reformer is regenerated during each starting phase. Since operation of the reformer as a kind of burner can serve both preheating the system and regeneration, the system can be regenerated to advantage every time it is started.

The invention relates furthermore to a system comprising a reformer and a controller permitting regeneration of the reformer, the controller being adapted to control a method in accordance with the invention.

The invention will now be detailed by way of preferred example embodiments with reference to the attached drawings in which:

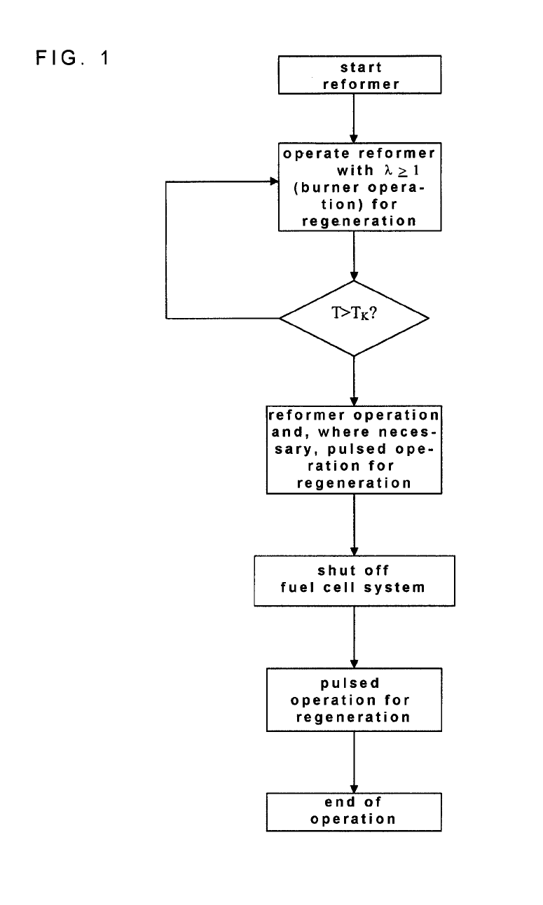

FIG. 1 is a flow diagram to assist in explaining a method in accordance with the invention;

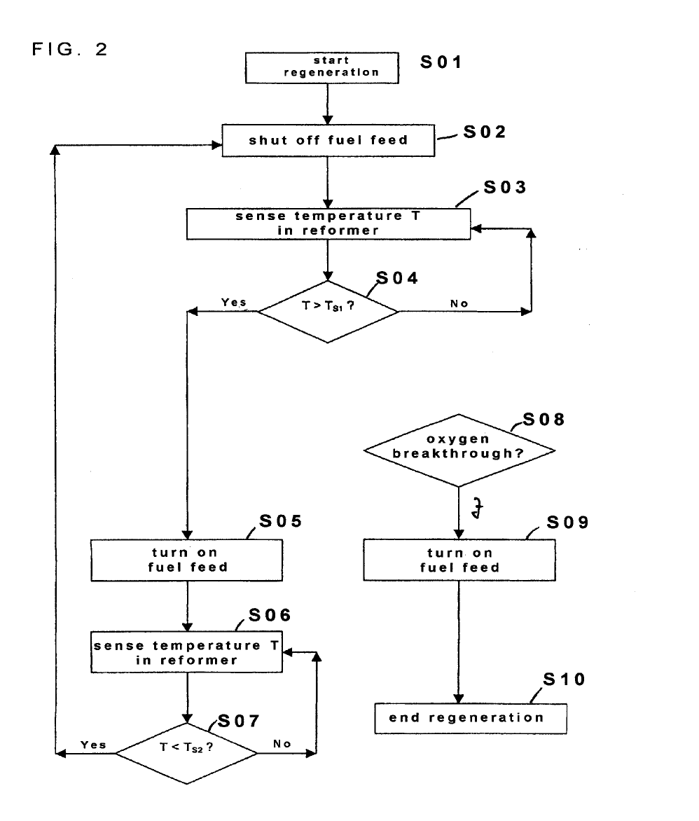

FIG. 2 is a flow diagram to assist in explaining regeneration during reformer operation; and

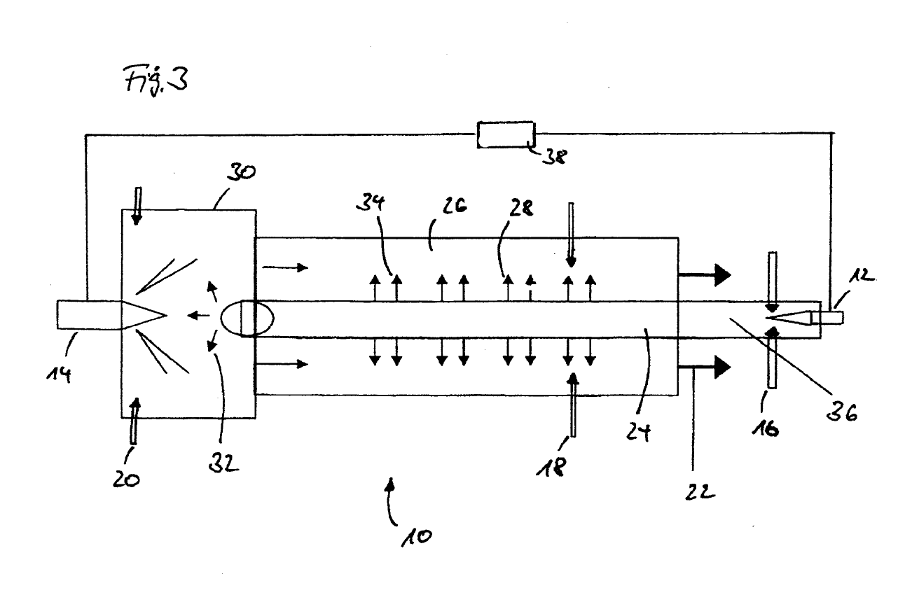

FIG. 3 is a diagrammatic illustration of a reformer in accordance with the invention.

Referring now to FIG. 1 there is illustrated a flow diagram to assist in explaining a method in accordance with the invention. Following the start of the reformer in step S01, the reformer is operated with an air number λ≧1, corresponding to operation as a burner. Burner operation serves regeneration by particularly removing carbon and its compounds and sulphur and its compounds from the reformer. Regeneration also has an effect on any other organic and inorganic compounds having become deposited in the reformer. This is followed in step S03 by sensing whether a temperature T has already exceeded a critical value T_{K}. This critical value can be established by the reformer itself determining, for example, the upper temperature value permissible for the catalyst in the reforming zone or also as dictated by the fuel cell stack downstream of the reformer. It is particularly at temperatures exceeding 500° C. that the fuel cell stack must not be charged with oxygen to thus avoid a heavy superstoichiometric inflow of oxygen into the reformer above one such critical temperature. As long as the critical temperature is not attained the reformer continues to be operated as a burner. But if the critical temperature is exceeded, the reformer enters into normal operation as a reformer as per step 04. If need be, for further regeneration pulsed operation can be initiated as described with reference to FIG. 3. If, in step S05, the fuel cell stack is shut off, the involved shutoff phase of the reformer can be utilized for further regeneration in pulsed operation as per step S06. This is followed by operation of the reformer being terminated (step S07).

Referring now to FIG. 2 there is illustrated a flow diagram to assist in explaining regeneration during operation of the reformer. After starting regeneration of the reformer in step S01 the fuel feed is shut off in step S02. Then in step S03 a temperature in the reformer is sensed, in step S04 it being determined whether the sensed temperature is higher than a predefined threshold value T_{S1}. If it is not, the temperature in the reformer is again sensed as per step S03 with the fuel feed shut off. If it is sensed in step S04 that the temperature exceeds the predefined threshold value T_{S1}, the fuel feed is returned ON in step S05. This is followed in step S06 in that the temperature in the reformer again is sensed. In step S07 it is determined whether this sensed temperature is lower than a predefined threshold value T_{S2}. If it is not, the temperature in the reformer is again sensed as per step S06, without shutting off the fuel feed. If it is sensed in step S07 that the temperature is lower than the predefined threshold value T_{S2} the fuel feed is again shut off as per step S02 so that the next time interval for reformer generation can commence.

Parallel to monitoring the temperature, oxygen breakthrough in the reformer is monitored in step S08. This serves to establish the end of regeneration. Thus, when an oxygen breakthrough occurs and the fuel feed is shut off, then in step S09 the fuel feed is returned ON, after which regeneration ends with step S10.

Referring now to FIG. 3 there is illustrated a diagrammatic illustration of a reformer in accordance with the invention. The invention is not restricted to the special configuration of the reformer as shown here. Instead, regeneration in accordance with the invention can take place in various types of reformer as long as it is possible to reduce or interrupt the fuel feed at short notice. The reformer 10 as shown here which is based on the principle of partial oxidation preferably without a steam feed can be fed with fuel 12 and oxidant 16 via respective feeds. A possible fuel 12 is for instance diesel, the oxidant 16 as a rule is air. The reaction heat resulting as soon as combustion commences can be partly removed in an optional cooling zone 36. The mixture then enters the oxidation zone 24 which may be realized as a tube arranged within the reforming zone 26. In alternative embodiments the oxidation zone is realized by a plurality of tubes or by a special tubing arrangement within the reforming zone 26. In the oxidation zone the conversion of fuel and oxidant takes place in an exothermic reaction with λ≈1. The resulting gas mixture 32 then enters an injection and mixing zone 30 in which it is mixed with fuel 14, whereby the thermal energy of the gas mixture 32 can support evaporation of the fuel 14. It may be provided for in addition that the injection and mixing zone 30 is fed with an oxidant. The mixture formed in this way then enters the reforming zone 26 where it is converted in an endothermic reaction with e.g. λ≈0.4. The heat 28 needed for the endothermic reaction is taken from the oxidation zone 24. To optimize the reforming process additional oxidant 18 can be fed into the reforming zone 26. It is furthermore possible to feed part of the gas mixture 34 generated in the oxidation zone 24 directly to the reforming zone 26 in bypassing the injection and mixing zone 30. The reformate 22 then flows from the reforming zone 26 and is available for further applications.

Assigned to the reformer is a controller 38 which, among other things, can control the primary fuel feed 12 as well as the secondary fuel feed 14.

To undertake regeneration of the reforming zone 26 in the example embodiment as shown in FIG. 3 it may be sufficient to shut off the fuel feed 14 pulsed whilst the fuel feed 12 for maintaining the oxidant in the reformer is operated with no change in the feed rate. The catalyst provided in the reforming zone 26 is then burnt off with waste combustion gases containing oxygen.

It is understood that the features of the invention as disclosed in the present description, drawings as well as in the claims may be essential to achieving the invention both singly and in any combination.

### LIST OF REFERENCE NUMERALS

12 fuel
14 fuel
16 oxidant
18 oxidant
20 oxidant
22 reformate
24 oxidation zone
26 reforming zone
28 heat
30 injection and mixing zone
34 gas mixture
36 cooling zone
38 controller

1. A method for regenerating a reformer fed with a mixture of fuel and an oxidant having a mean air number λ₁ in continuous reformer operation, the air number being varied for the purpose of regenerating the reformer, characterized in that regeneration in a shutoff phase of the reformer is achieved in that the reformer is operated during several successive time intervals with an air number λ₂ higher than in reformer operation (λ₂>λ₁).

2. The method of claim 1, characterized in that the feed rate of the fuel amounts to zero during at least one of the successive time intervals.

3. The method of claim 1, characterized in that
the oxygen content in the substances leaving the reformer is measured, and
the reformer translates into continuous operation when the oxygen content exceeds a threshold value.

4. The method of claim 1, characterized in that the oxygen content is measured by a lambda sensor.

5. The method of claim 1, characterized in that the oxygen content is measured by a fuel cell.

6. The method of claim 1, characterized in that with a reformer having a dual fuel feed, one of the fuel feeds works during regeneration with a feed rate which substantially corresponds to the feed rate in continuous operation.

7. The method of claim 6, characterized in that
the reformer comprises an oxidation zone and a reforming zone,
the reforming zone is provided with heat,
the oxidation zone is fed with a mixture of fuel and oxidant in using a first fuel feed, the mixture being feedable after oxidation of the fuel at least in part to the reforming zone at least in part,
the reforming zone is feedable with additional fuel by using a second fuel feed and
the second fuel feed works during the successive time intervals with a reduced feed rate.

8. The method of claim 7, characterized in that the reforming zone can be provided with heat from the exothermic oxidation in the oxidation zone.

9. The method of claim 7, characterized in that the reforming zone comprises an oxidant feed via which additional oxidant is feedable.

10. The method of claim 7, characterized in that
additional fuel is feedable to an injection and mixing zone, and
the additional fuel can flow from the injection and mixing zone into the reforming zone.

11. The method of claim 7, characterized in that the additional fuel is evaporated at least in part by the thermal energy of the gas mixture emerging from the oxidation zone.

12. The method of claim 10, characterized in that the gas mixture generated in the oxidation zone is feedable to the reforming zone partly in bypassing the injection and mixing zone.

13. The method of claim 1, characterized in that regeneration occurs during each shutoff phase of the reformer.

14. A method for regenerating a reformer fed with a mixture of fuel and an oxidant having a mean air number λ₁ in continuous reformer operation, the air number being varied for the purpose of regenerating the reformer of claim 1, characterized in that regeneration occurs in a starting phase of the reformer in that the reformer is continually operated with an air number λ₂ increased as compared to reformer operation (λ₂>λ₁) until a critical temperature threshold is attained.

15. The method of claim 14, characterized in that the reformer is operated in the starting phase with an air number λ≧1.

16. The method of claim 14, characterized in that the critical temperature threshold is defined in that the reformer or its components feature temperatures between 450 and 650° C.

17. The method of claim 14, characterized in that the critical temperature threshold is defined in that a fuel cell stack or its components downstream of the reformer feature temperatures between 450 and 550° C.

18. The method of claim 14, characterized in that the reformer is regenerated following its starting phase by the reformer being operated during several successive time intervals with an air number elevated as compared to that in reformer operation.

19. The method of claim 1, characterized in that the regeneration occurs during each starting phase of the reformer.

20. A system including a reformer and a controller permitting regeneration of the reformer, the controller being adapted to control a method of claim 1.
